(19) United States
(12) Patent Application Publication
(10) Pub. No.: US 2026/0255332 A1
(43) Pub. Date: Aug. 27, 2026

(54) FREQUENCY CALIBRATION METHOD FOR WIRELESS NETWORK DEVICE, ELECTRONIC DEVICE AND COMPUTER READABLE STORAGE MEDIUM

(71) Applicant: Nanning FuLian FuGui Precision Industrial Co., Ltd., Nanning (CN)

(72) Inventor: JIAN-YOU GUO, Hsinchu City (TW)

(21) Appl. No.: 19/063,502

(22) Filed: Feb. 26, 2025

(51) Int. Cl. H04W 72/0453; H04W 84/12

(52) U.S. Cl. CPC H04W 72/0453; H04W 84/12

(57) ABSTRACT

A frequency calibration method for wireless network device, an electronic device and a computer readable storage medium are disclosed. During a preprocessing period, a frequency calibration accuracy test operation is performed on a Wi-Fi 6G antenna module of the electronic device to confirm that a center frequency of a first channel of the UNII5 frequency band of the Wi-Fi 6G antenna module can be offset by a preset frequency. During an operation period, a frequency band detection operation is performed on the Wi-Fi 6G antenna module to determine whether noise is detected within a preset frequency band range. If the noise is detected within the preset frequency band range, the center frequency of the UNII5 frequency band of the Wi-Fi 6G antenna module is offset from the preset frequency.

### FIELD

The disclosure relates to quality management, and more particularly to a frequency calibration method for wireless network device, an electronic device and a computer readable storage medium.

### BACKGROUND

Wi-Fi access points (Access Points) or Wi-Fi routers generally have noise interference problems at the 5945 MHz of the antenna receiving end, resulting in reduced network throughput and deterioration of total isotropic sensitivity (TIS).

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of a frequency calibration method for wireless network device of the present disclosure;

FIG. 2 is a schematic diagram of an embodiment of experimental data of Wi-Fi traffic of the present disclosure;

FIG. 3 is a schematic diagram of an embodiment of experimental data of Wi-Fi total isotropic sensitivity (TIS) of the present disclosure;

FIG. 4 is a schematic diagram of an embodiment of experimental data of Wi-Fi in-phase quadrature (IQ) signals of the present disclosure;

FIG. 5 is a block diagram of an embodiment of the hardware architecture of an electronic device using the a frequency calibration method of the present disclosure; and

FIG. 6 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

In an embodiment of a frequency calibration method for wireless network device of the present disclosure, according to the Institute of Electrical and Electronics Engineers (IEEE) 802.11 specification, a center frequency of the first channel (5955 MHz) of Wi-Fi 6G can be offset by 120KHz, 6 GHZ×20 ppm=±120 KHz to reduce the noise interference of 5955 MHz. Experiments have shown that the purpose of reducing noise interference can be achieved by shifting only 40 KHz.

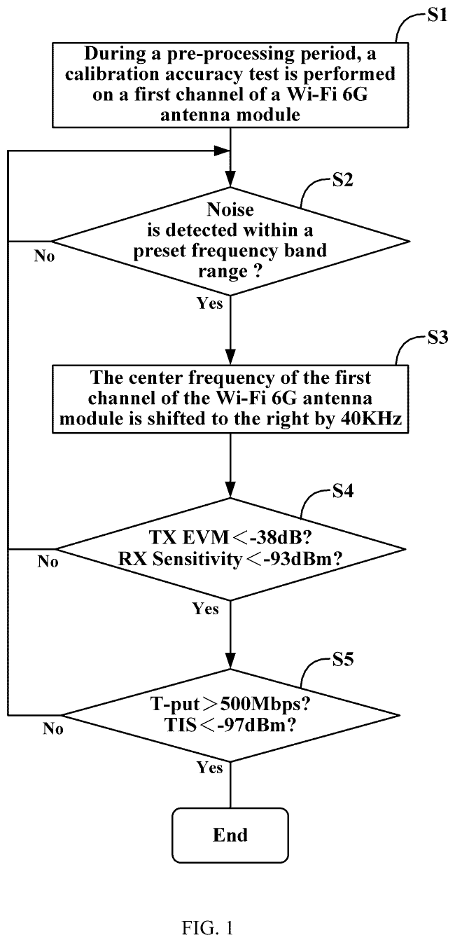

FIG. 1 is a flowchart of an embodiment of a frequency calibration method for wireless network device of the present disclosure, which is applied to an electronic device. According to different needs, the order of the steps in the flowchart can be changed, and some steps can be omitted. The electronic device may be a Wi-Fi access point (AP), a Wi-Fi router, or any Wi-Fi device with a wireless network connection function.

In step S1, during a pre-processing period, a frequency calibration accuracy test is performed on the electronic device, that is, a calibration accuracy test is performed on the first channel (Channel 1) of the UNII5 frequency band of a Wi-Fi 6G antenna module of the electronic device, confirming that a center frequency of the first channel of the UNII5 frequency band of the Wi-Fi 6G antenna module can be accurately shifted to the right by 40 KHz, i.e., 5955 MHz+40 KHz.

In step S2, during an operation period, frequency band detection is performed on the first channel of the UNII5 frequency band of the Wi-Fi 6G antenna module of the electronic device to determine whether noise (Noise Floor) is detected within a preset frequency band range (e.g., 5925 MHz~5955 MHz), such as noise with RSSI>−60dBm. The Wi-Fi 6G antenna module has a receiving port sensing (RX Sensing) function for detecting whether there is noise on the first channel.

In step S3, if the noise is detected within the preset frequency band range, the center frequency of the first channel of the UNII5 frequency band of the Wi-Fi 6 G antenna module is shifted to the right by 40 KHz, i.e., 5955 MHz+40 KHz.

In step S4, a Wi-Fi specification test is performed on the Wi-Fi 6G antenna module to determine whether an error vector magnitude (EVM) of a transmission port (TX) and sensitivity of a receiving port (RX) of the first channel of the UNII5 frequency band of the Wi-Fi 6G antenna module comply with the IEEE specification, for example, TX EVM <−38 dBm and RX Sensitivity <−93 dBm.

In step S5, if the EVM and the sensitivity comply with the IEEE specification, a Wi-Fi interference test is performed on the Wi-Fi 6G antenna module, including a throughput (T-put) test and a total isotropic sensitivity (TIS) test, to determine whether the throughput and the TIS of the first channel of the UNII5 frequency band of the Wi-Fi 6 G antenna module meet preset conditions, for example, T-put>500 Mbps and TIS<−97 dBm. If T-put>500 Mbps and TIS<−97dBm, the method process is terminated.

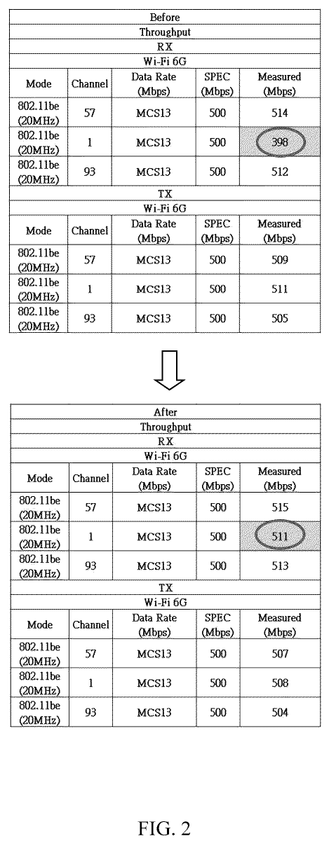

FIG. 2 is a schematic diagram of an embodiment of experimental data of Wi-Fi traffic of the present invention. As the center frequency of the first channel of the UNII 5 band of the Wi-Fi 6G antenna module was offset, T-put increased from 398 Mbps to 511 Mbps, providing an improvement of 28.4%.

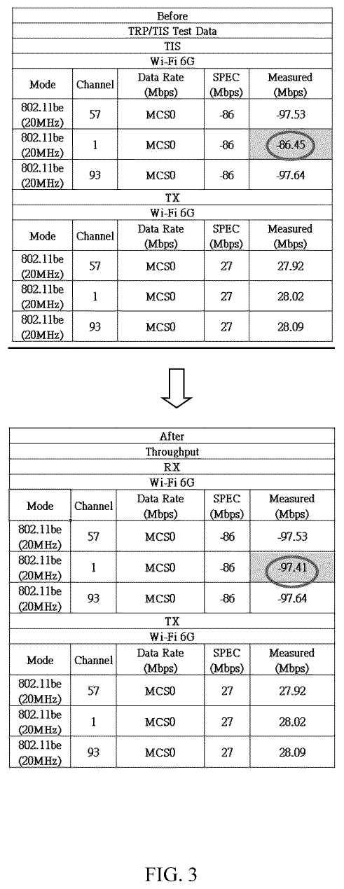

FIG. 3 is a schematic diagram of an embodiment of experimental data of the TIS of the present invention. As the center frequency of the first channel of the UNII5 band of the Wi-Fi 6G antenna module was offset, the TIS is improved by 11 dBm.

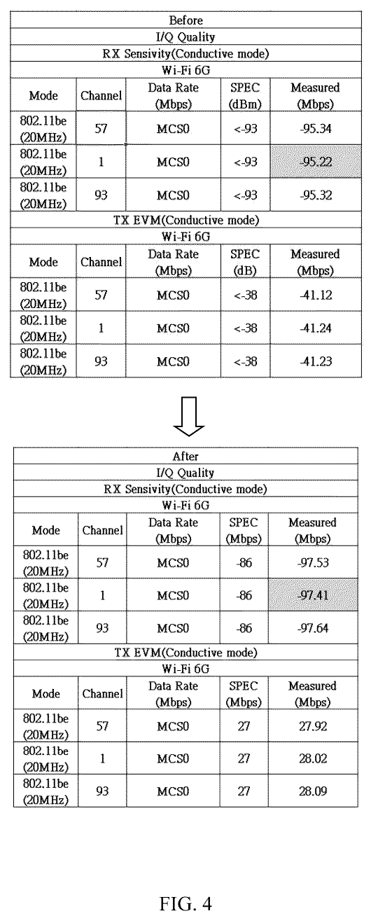

FIG. 4 is a schematic diagram of an embodiment of experimental data of Wi-Fi IQ signals of the present invention. The TX EVM and RX Sensitivity are not affected before and after the center frequency of the first channel of the UNII5 band of the Wi-Fi 6G antenna module is offset.

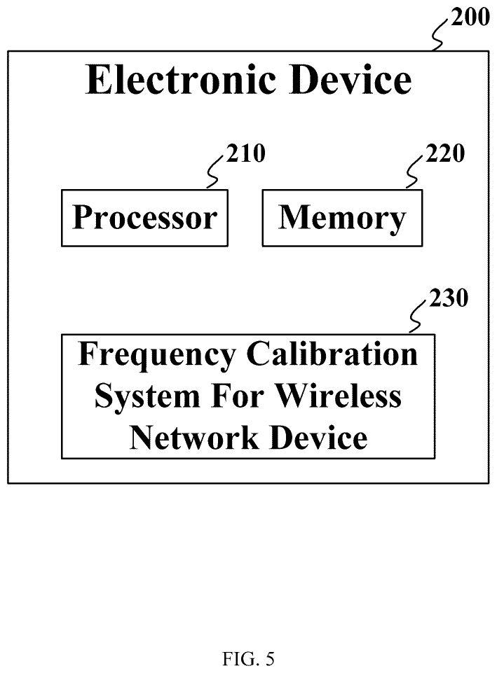

FIG. 5 is a block diagram of an embodiment of the hardware architecture of an electronic device using the frequency calibration method for wireless network device of the present disclosure. The electronic device 200 may be, but is not limited to, connected to a processor 210, a memory 220, and a frequency calibration system for wireless network device 230 via system buses. The electronic device 200 shown in FIG. 5 may include more or fewer components than those illustrated or may combine certain components.

The memory 220 stores a computer program, such as the frequency calibration system for wireless network device 230, which is executable by the processor 210. When the processor 210 executes the frequency calibration system for wireless network device 230, the blocks in one embodiment of the booting mode configuration method applied in the electronic device 200 are implemented, such as blocks S1 to S5 shown in FIG. 1.

It will be understood by those skilled in the art that FIG. 5 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the frequency calibration system for wireless network device 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The frequency calibration system for wireless network device 230 can be partitioned into one or more modules/units that are stored in the memory 220 and executed by the processor 210. The one or more modules/units may be a series of computer program instructions capable of performing particular functions of the frequency calibration system for wireless network device 230.

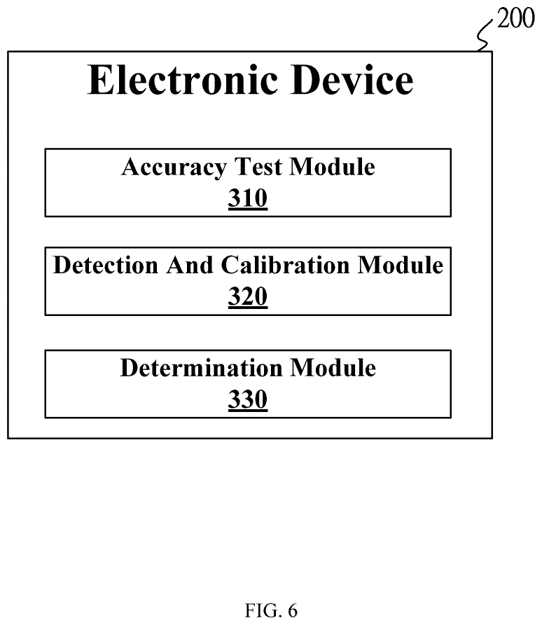

FIG. 6 is a schematic diagram of an embodiment of functional blocks of the electronic device using the method of the present disclosure.

The electronic device 200 comprises an accuracy test module 310, a detection and calibration module 320 and a determination module 330.

During a pre-processing period, the accuracy test module 310 performs a frequency calibration accuracy test on the electronic device, that is, a calibration accuracy test is performed on the first channel (Channel 1) of the UNII5 frequency band of a Wi-Fi 6G antenna module of the electronic device, confirming that a center frequency of the first channel of the UNII5 frequency band of the Wi-Fi 6G antenna module can be accurately shifted to the right by 40 KHz, i.e., 5955 MHz+40 KHz.

During an operation period, the detection and calibration module 320 performs frequency band detection on the first channel of the UNII5 frequency band of the Wi-Fi 6G antenna module to determine whether noise (Noise Floor) is detected within a preset frequency band range (e.g., 5925 MHz~5955 MHz), such as noise with RSSI >−60 dBm. The Wi-Fi 6G antenna module has a receiving port sensing (RX Sensing) function for detecting whether there is noise on the first channel.

If the noise is detected within the preset frequency band range, the detection and calibration module 320 enables the center frequency of the first channel of the UNII5 frequency band of the Wi-Fi 6G antenna module to shift to the right by 40 KHz, i.e., 5955MHz+40 KHz.

The determination module 330 performs a Wi-Fi specification test on the Wi-Fi 6G antenna module to determine whether an error vector magnitude (EVM) of a transmission port (TX) and sensitivity of a receiving port (RX) of the first channel of the UNII5 frequency band of the Wi-Fi 6G antenna module comply with the IEEE specification, for example, TX EVM<−38dBm and RX Sensitivity<−93dBm.

If the EVM and the sensitivity comply with the IEEE specification, the determination module 330 performs a Wi-Fi interference test on the Wi-Fi 6G antenna module, including a throughput (T-put) test and a total isotropic sensitivity (TIS) test, to determine whether the throughput and the TIS of the first channel of the UNII5 frequency band of the Wi-Fi 6G antenna module meet preset conditions, for example, T-put>500 Mbps and TIS<−97 dBm. If T-put>500 Mbps and TIS<−97 dBm, the method process is terminated.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A frequency calibration method configured for a wireless network device and executable by an electronic device, comprising:
during a pre-processing period, performing a frequency calibration accuracy test operation on a Wi-Fi 6G antenna module of the electronic device to confirm that a center frequency of a first channel of a UNII5 frequency band of a Wi-Fi 6G antenna module is offset by a preset frequency;
during an operation period, performing a frequency band detection operation on the Wi-Fi 6G antenna module to determine whether noise is detected within a preset frequency band interval; and
shifting the center frequency of the UNII5 frequency band of the Wi-Fi 6G antenna module by the preset frequency if the noise is detected within the preset frequency band.

2. The method of claim 1, wherein the preset frequency is 40 KHz to 120 KHz.

3. The method of claim 1, further comprising:
performing a Wi-Fi specification test operation on the Wi-Fi 6G antenna module to determine whether an error vector magnitude (EVM) of a transmitting connection port (TX) and a sensitivity of a receiving connection port (RX) of a first channel of the UNII5 frequency band of the Wi-Fi 6G antenna module comply with IEEE specifications.

4. The method of claim 3, further comprising
determining whether the EVM is less than −38 dBm and whether the sensitivity is less than −93 dBm.

5. The method of claim 3, further comprising
if the EVM and the sensitivity comply with the IEEE specifications, performing a Wi-Fi interference test on the Wi-Fi 6G antenna module to determine whether throughput of the first channel of the UNII5 frequency band of the Wi-Fi 6G antenna module and a total isotropic sensitivity (TIS) meet preset conditions.

6. The method of claim 5, further comprising
determining whether the throughput is greater than 500 Mbps and whether the TIS is less than −97 dBm.

7. An electronic device, which includes a memory, a processor, and a serial number length adjustment program stored in the memory and operable on the processor, wherein the frequency calibration program is executed by the processor to implement following instructions:
during a pre-processing period, performing a frequency calibration accuracy test operation on a Wi-Fi 6G antenna module of the electronic device to confirm that a center frequency of a first channel of a UNII5 frequency band of a Wi-Fi 6G antenna module is offset by a preset frequency;
during an operation period, performing a frequency band detection operation on the Wi-Fi 6G antenna module to determine whether noise is detected within a preset frequency band interval; and
shifting the center frequency of the UNII5 frequency band of the Wi-Fi 6G antenna module by the preset frequency if the noise is detected within the preset frequency band.

8. The device of claim 7, wherein the preset frequency is 40 KHz to 120 KHz.

9. The device of claim 7, wherein the frequency calibration program is further executed by the processor to implement following instructions:
performing a Wi-Fi specification test operation on the Wi-Fi 6G antenna module to determine whether an EVM of a transmitting connection port (TX) and a sensitivity of a receiving connection port (RX) of a first channel of the UNII5 frequency band of the Wi-Fi 6G antenna module comply with IEEE specifications.

10. The device of claim 9, wherein the frequency calibration program is further executed by the processor to implement following instructions:
determining whether the EVM is less than −38 dBm and whether the sensitivity is less than −93 dBm.

11. The device of claim 9, wherein the frequency calibration program is further executed by the processor to implement following instructions:
if the EVM and the sensitivity comply with the IEEE specifications, performing a Wi-Fi interference test on the Wi-Fi 6G antenna module to determine whether throughput of the first channel of the UNII5 frequency band of the Wi-Fi 6G antenna module and a total isotropic sensitivity (TIS) meet preset conditions.

12. The device of claim 11, wherein the frequency calibration program is further executed by the processor to implement following instructions:
determining whether the throughput is greater than 500 Mbps and whether the TIS is less than −97 dBm.

13. A non-transitory computer-readable storage medium storing game program which causes a computer to execute:
a process of, during a pre-processing period, performing a frequency calibration accuracy test operation on a Wi-Fi 6G antenna module of the electronic device to confirm that a center frequency of a first channel of a UNII5 frequency band of a Wi-Fi 6G antenna module is offset by a preset frequency;
a process of, during an operation period, performing a frequency band detection operation on the Wi-Fi 6G antenna module to determine whether noise is detected within a preset frequency band interval; and
a process of shifting the center frequency of the UNII5 frequency band of the Wi-Fi 6G antenna module by the preset frequency if the noise is detected within the preset frequency band.

14. The non-transitory computer-readable storage medium of claim 13, wherein the preset frequency is 40 KHz to 120 KHz.

15. The non-transitory computer-readable storage medium of claim 13, wherein game program further causes the computer to execute:
a process of performing a Wi-Fi specification test operation on the Wi-Fi 6G antenna module to determine whether an error vector magnitude (EVM) of a transmitting connection port (TX) and a sensitivity of a receiving connection port (RX) of a first channel of the UNII5 frequency band of the Wi-Fi 6G antenna module comply with IEEE specifications.

16. The non-transitory computer-readable storage medium of claim 15, wherein game program further causes the computer to execute:
a process of determining whether the EVM is less than −38 dBm and whether the sensitivity is less than −93 dBm.

17. The non-transitory computer-readable storage medium of claim 15, wherein game program further causes the computer to execute:
a process of, if the EVM and the sensitivity comply with the IEEE specifications, performing a Wi-Fi interference test on the Wi-Fi 6G antenna module to determine whether throughput of the first channel of the UNII5 frequency band of the Wi-Fi 6G antenna module and a total isotropic sensitivity (TIS) meet preset conditions.

18. The non-transitory computer-readable storage medium of claim 17, wherein game program further causes the computer to execute:
a process of determining whether the throughput is greater than 500 Mbps and whether the TIS is less than −97 dBm.
